(19) United States
(12) Patent Application Publication
(10) Pub. No.: US 2006/0085375 A1
(43) Pub. Date: Apr. 20, 2006

(54) Method and system for access plan sampling

(75) Inventors: Randy L. Egan, Rochester, MN (US); Mark Larry Holm, Rochester, MN (US); Brian Robert Muras, Rochester, MN (US)

Correspondence Address: Steven W. Roth;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/965,189

(22) Filed: Oct. 14, 2004

(51) Int. Cl. G06F 17/30

(52) U.S. Cl. 707/1

(57) ABSTRACT

A method for selecting an access plan includes analyzing a plurality of access plans for a particular query and a plurality of low cost access plans for the particular query are identified. Each time a subsequent query, similar to the initial query, is encountered, one of the low cost access plans is executed. In a particular, the low cost access plans may be randomly selected and executed and their execution performance may be monitored to identify an optimal access plan of all the low cost access plans.

### FIELD OF THE INVENTION

The invention relates to database management systems, and in particular, to modifying automatically generated access plans.

### BACKGROUND OF THE INVENTION

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous computing resources to handle the heavy workloads placed on such systems. As such, significant efforts have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems.

From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database. Furthermore, significant development efforts have been directed toward query “optimization”, whereby the execution of particular searches, or queries, is optimized in an automated manner to minimize the amount of resources required to execute each query.

Through the incorporation of various hardware and software improvements, many high performance database management systems are able to handle hundreds or even thousands of queries each second, even on databases containing millions or billions of records. However, further increases in information volume and workload are inevitable, so continued advancements in database management systems are still required.

One area that has been a fertile area for academic and corporate research is that of improving the designs of the cost-based “query optimizers” utilized in many conventional database management systems. As stated, the primary task of a query optimizer is to choose the most efficient way to execute each database query, or request, passed to the database management system by a user. The output of an optimization process is typically referred to as an “execution plan,” “access plan,” or just “plan” and is frequently depicted as a tree graph. Such a plan typically incorporates (often in a proprietary form unique to each optimizer/DBMS) low-level information telling the database engine that ultimately handles a query precisely what steps to take (and in what order) to execute the query. Also typically associated with each generated plan is an optimizer's estimate of how long it will take to run the query using that plan.

A cost-based optimizer's job is often necessary and difficult because of the enormous number (i.e., “countably infinite” number) of possible query forms that can be generated in a database management system, e.g., due to factors such as the use of SQL queries with any number of relational tables made up of countless data columns of various types, the theoretically infinite number of methods of accessing the actual data records from each table referenced (e.g., using an index, a hash table, etc.), the possible combinations of those methods of access among all the tables referenced, etc. A cost-based optimizer is often permitted to rewrite a query (or portion of it) into any equivalent form, and since for any given query there are typically many equivalent forms, an optimizer has a countably infinite universe of extremely diverse possible solutions (plans) to consider. On the other hand, an optimizer is often required to use minimal system resources given the desirability for high throughput. As such, a cost-based optimizer often has only a limited amount of time to pare the search space of possible execution plans down to an optimal plan for a particular query.

One manner of increasing the performance of a cost-based optimizer is to utilize an access plan “cache” that stores previously-generated access plans for given queries. As a result, when a new query is received that matches another query previously processed by the optimizer, the access plan previously generated for that prior query can be retrieved and executed, thus saving the processing overhead associated with generating a new access plan. Further, in some optimizers, different access plans may be generated for different execution environments, e.g., based upon different host variables, degrees of parallelism, memory pool sizes, and other environmental parameters, such that a different access plan from an access plan cache will be executed for a given query based upon the current environment under which the query will be executed.

One problem associated with conventional cost-based optimizers, however, arises due to the fact that such optimizers always select an access plan with the lowest estimated cost even if other access plans were developed with very similar (but slightly higher) estimated costs. The actual cost of executing an access plan, however, does not always match the estimated cost for the access plan. As a result, in practice some alternative plans that are estimated to have a higher cost than a particular access plan deemed to have the lowest estimated cost may actually end up executing faster or providing better performance. By executing only access plans with the lowest estimated costs, however, the fact that an alternative access plan with a higher estimated cost ultimately has a lower actual cost may never be recognized by a cost-based optimizer.

Accordingly, in situations where actual costs can differ somewhat from estimated costs, a likelihood exists that a cost-based optimizer may select suboptimal access plans. A significant need therefore continues to exist for a manner of improving the selection of optimal access plans.

### SUMMARY OF THE INVENTION

Embodiments of the present invention relate to a database system that includes a cost-based optimizer for generating access plans, and that bases the selection of an optimal access plan upon actual cost information generated from the execution of multiple alternative access plans for similar or identical queries. As a result, an access plan having optimal performance in actual usage often may be selected by a cost-based optimizer irrespective of any inconsistencies that may arise between the estimated costs generated by the cost-based optimizer.

Consistent with one aspect of the invention, an optimal access plan is selected by selecting a plurality of alternative access plans for a particular query based upon estimated costs associated with each alternative access plan, and executing the plurality of alternative access plans to generate actual costs for the plurality of alternative access plans. The optimal access plan is then identified from among the plurality of alternative access plans based upon the generated actual costs associated with each such access plan.

Consistent with another aspect of the invention, an access plan is selected by executing one of a plurality of similar-cost access plans for each of a plurality of similar queries, and identifying therefrom an access plan having better performance than the other plurality of similar-cost access plans. The identified access plan is then used for executing subsequent similar queries.

### BRIEF DESCRIPTION OF THE DRAWINGS

FIG. 1 is a block diagram of a networked computer system incorporating a database management system consistent with the invention.

FIG. 2 is a block diagram illustrating the principal components and flow of information therebetween in the database management system of FIG. 1.

FIG. 3 illustrates a flowchart of selecting alternative access plans in accordance with the principles of the present invention.

### DETAILED DESCRIPTION

As mentioned above, the embodiments discussed hereinafter utilize a database engine and optimizer framework that support selection from among a plurality of alternative access plans with similar cost estimates. Once the different alternative access plans are generated or retrieved, the execution engine may monitor the actual performance of the different plans and identify from actual cost information which plan provides the best performance.

A specific implementation of such a database engine and optimizer framework capable of supporting this functionality in a manner consistent with the invention will be discussed in greater detail below. However, prior to a discussion of such a specific implementation, a brief discussion will be provided regarding an exemplary hardware and software environment within which such an optimizer framework may reside.

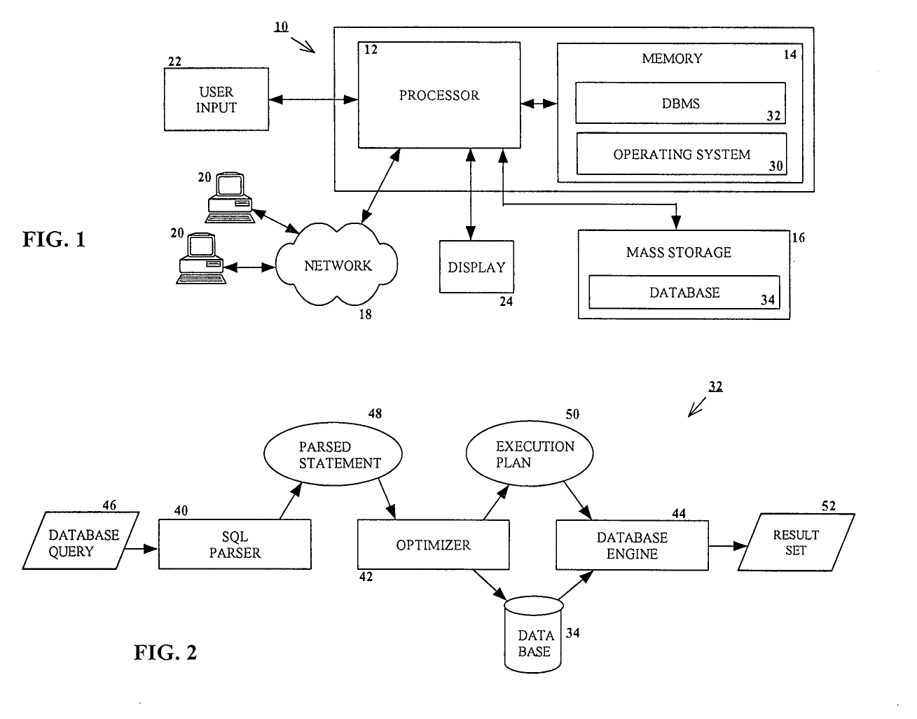

Turning now to the Drawings, wherein like numbers denote like parts throughout the several views, FIG. 1 illustrates an exemplary hardware and software environment for an apparatus 10 suitable for implementing a database management system that permits generating and using multiple access plans for the same query. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer”, although it should be appreciated the term “apparatus” may also include other suitable programmable electronic devices consistent with the invention.

Computer 10 typically includes at least one processor 12 coupled to a memory 14. Processor 12 may represent one or more processors (e.g., microprocessors), and memory 14 may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor 12, as well as any storage capacity used as a virtual memory, e.g., as stored on a mass storage device 16 or on another computer coupled to computer 10 via network 18 (e.g., a client computer 20).

Computer 10 also typically receives a number of inputs and outputs for communicating information externally. For interface with a user or operator, computer 10 typically includes one or more user input devices 22 (e.g., a keyboard, a mouse, a trackball, a joystick, a touchpad, and/or a microphone, among others) and a display 24 (e.g., a CRT monitor, an LCD display panel, and/or a speaker, among others). Otherwise, user input may be received via another computer (e.g., a computer 20) interfaced with computer 10 over network 18, or via a dedicated workstation interface or the like.

For additional storage, computer 10 may also include one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may include an interface with one or more networks 18 (e.g., a LAN, a WAN, a wireless network, and/or the Internet, among others) to permit the communication of information with other computers coupled to the network. It should be appreciated that computer 10 typically includes suitable analog and/or digital interfaces between processor 12 and each of components 14, 16, 18, 22 and 24 as is well known in the art.

Computer 10 operates under the control of an operating system 30, and executes or otherwise relies upon various computer software applications, components, programs, objects, modules, data structures, etc. (e.g., database management system 32 and database 34, among others). Moreover, various applications, components, programs, objects, modules, etc. may also execute on one or more processors in another computer coupled to computer 10 via a network 18, e.g., in a distributed or client-server computing environment, whereby the processing required to implement the functions of a computer program may be allocated to multiple computers over a network.

Turning briefly to FIG. 2, an exemplary implementation of database management system 32 is shown. The principal components of database management system 32 that are relevant to query optimization are an SQL parser 40, cost-based optimizer 42 and database engine 44. SQL parser 40 receives from a user a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated, often using data such as platform capabilities, query content information, etc., that is stored in database 34. Once generated, the execution plan is forwarded to database engine 44 for execution of the database query on the information in database 34. The result of the execution of the database query is typically stored in a result set, as represented at block 52.

Other components may be incorporated into system 32, as may other suitable database management architectures. Other database programming and organizational architectures may also be used consistent with the invention. Therefore, the invention is not limited to the particular implementation discussed herein.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIGS. 1 and 2 is not intended to limit the present invention. Indeed, those skilled in the art will recognize that other alternative hardware and/or software environments may be used without departing from the scope of the invention.

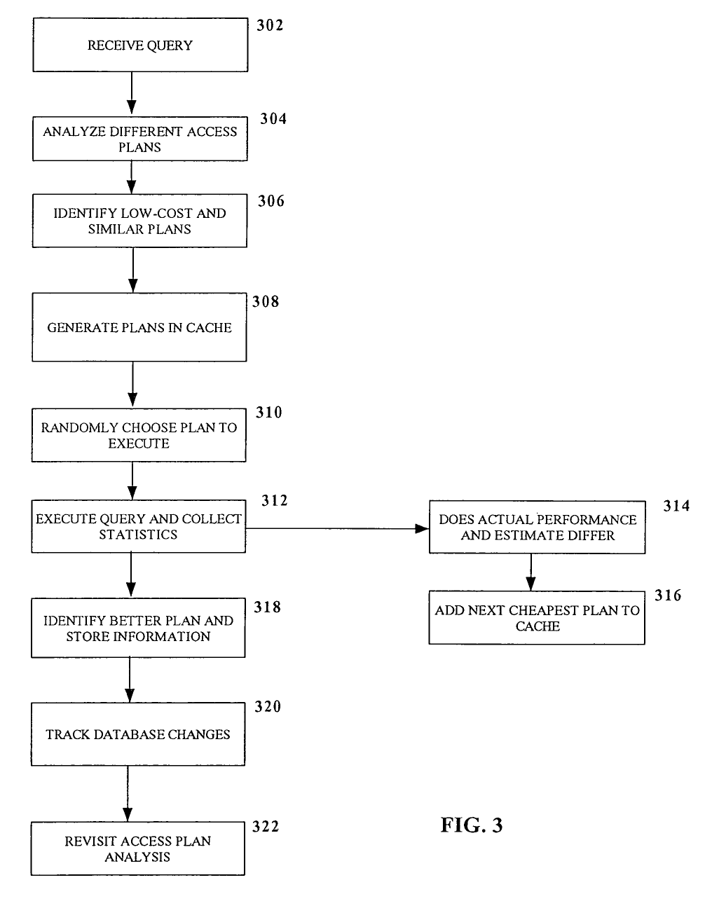

FIG. 3 illustrates a flowchart of an exemplary method of practicing the principles of the present invention. In accordance with the flowchart, multiple access plans for the same query are generated, executed and monitored to determine the better access plan based on actual performance, and not just the estimated cost. Such an arrangement is more than just providing different access plan for a query depending on what the environmental parameters are (e.g., parallelism, memory size, host variables, etc.).

Instead, two or more plans are available in the access plan cache for identical queries and environmental parameters and both are executed to identify and remove the lower performing plan.

In step 302, a query is received from a user by the SQL parser and forwarded to the optimizer. The first time a query is received, the optimizer develops an access plan for the query; whereas when a previously used query is received, the optimizer locates an existing access plan in a cache or similar memory.

So, in step 304, the initial receipt of the query results in the analysis of various access plans for accomplishing the query. As mentioned above, the optimizer selects from among different alternatives for accomplishing the query and assigns an estimated cost (i.e., how long will it take to execute) to each access plan. Traditionally, the access plan with the lowest cost would be selected for the query and the remaining access plans discarded.

However, in accordance with the principles of the present invention, the optimizer identifies the low cost plan as well as other potential plans that fall within a predetermined threshold of the low cost plan. In some instances, no alternative plans will be within the predetermined threshold and only one plan will be generated. However, in certain cases, two or more access plans may be identified that have very similar cost estimates, and that are all alternative plans for executing the same basic query. For example, one access plan may have an estimated cost of 10.001 seconds and another plan may have an estimated cost of 10.00199 seconds. These estimated costs are substantially similar and, considering the granularity of many optimizers, may be considered to be essentially the same value.

In many embodiments, the analysis of the difference between access plan costs is not considered in an absolute sense. For example, an access plan that has an estimate of 0.001 seconds and another access plan that has a cost estimate of 0.00199 are significantly different (i.e., one is about twice as long as the other). However, the absolute difference between the two costs is the same as the first example above. Thus, in many embodiments the predetermined threshold is a relative threshold such that access plans which differ by approximately less than a predetermined percentage (e.g., about 51%) are considered to be similar in cost.

Thus, in step 306, the optimizer in accordance with the principles of the present invention identifies the low cost access plans as well as access plans with similar costs. Each of these access plans is generated in step 308 and stored in a plan cache to be available for incoming queries.

The optimizer then selects the plan that the database engine will execute. The low cost plan may initially be selected, in step 310, even though other plans are available. Other selection algorithms may be used in the alternative. For example, as multiple queries are received, the optimizer may randomly select from the available access plans which one to execute. Alternatively, another algorithm, such as a round robin algorithm, may be used to execute different alternative access plans for different queries. In this manner, each of the available access plan is desirably executed a number of times.

In step 312, the selected access plan is executed in order to return the query results. During the execution, the database engine maintains statistics about the execution. For example, statistics such as run time averages, standard deviation, and similar values can be logged each time an access plan is executed. These statistics may optionally be used to determine if an access plan is performing as expected. For example, in step 314, the database engine determines if the actual run time (on average) of the access plan significantly exceeds the estimated cost for the access plan. Again, a relative measurement is typically involved such that the difference between actual and estimated costs is not determined in an absolute sense. For example, an access plan that actually executes 10% or more slower than estimated may be identified as a possible access plan to discard or “prune” from the access plan cash, or alternatively, to correct, optimize or replace with an improved version. When collecting statistics about different plans, consideration should be taken that the first several runs of a plan may take longer as different tables and indices that are used are loaded into cached or main memory or the like.

As one option, in step 318, as a result of discovering the access plan's actual performance was far worse than estimated, a next cheapest access plan may be generated and added to the access plan cache. This may occur even if the next cheapest plan does not fit within the predetermined threshold identified previously. In connection with adding the new access plan, the original access plan, which was found to have suboptimal performance, may be discarded or pruned from the access plan cache.

Returning now to step 312, where the execution statistics are collected, the flowchart continues with step 318 wherein the better of the available access plans is identified. Once the collected statistics are statistically significant to reliably identify the better access plan, then all subsequent queries may be handled with that access plan. However, until that time, queries are assigned different available access plans and execution statistics are collected.

Once the better access plan is identified in step 318, information can be stored about the other access plans that were not selected. By storing information about the other access plans, rebuilding multiple access plans can be avoided. For example, if a rebuild operation is started for a particular access plan, then the stored information may be used to avoid rebuilding the other access plans and repeating the selection process.

Sometimes, however, a database may change over time in such a way that affects the execution performance of an access plan. The presence or absence of different indices, the structure of the data on the storage medium, and the addition and removal of different records contribute to the performance of a query access plan. As shown, for example, in step 320, it may be desirable for the database engine to monitor changes to the database. When it is determined that the database has undergone significant changes, then, in step 322, the access plan may be rebuilt along with other similar-cost access plans so that the selection process can be repeated.

Certain embodiments of the present invention may include additional features that may or may not be included in other embodiments. For example, the database system may determine initially whether there are enough system resources such as memory, microprocessors and the like to support the additional computations and statistics collecting of analyzing different access plans for the same query. Systems without enough resources may be limited on what aspects of the present invention are enabled. Also, the number of times a query is encountered may be tracked and used to determine when that query has significant enough use to warrant generating and analyzing the performance of multiple access plans. In addition, multiple alternative access plans may be executed for the same query, albeit typically with additional consumption of system resources. As another alternative, cached access plans may be executed in a background process, e.g., during periods of inactivity, to collect additional actual performance statistics for use in selecting an optimal access plan from among the available alternatives.

Accordingly, a system and method have been described that permit identifying and using multiple plans to handle a query in order to select the better performing access plan.

Various modifications may be made to the illustrated embodiments consistent with the invention. For example, in many environments, it may be desirable to perform the selection of optimal access plans as described herein only on access plans that are expected to be executed numerous times (e.g., hundreds or thousands of times within an hour or day). Furthermore, given that it may be difficult to ascertain a priori how many times a given access plan will be used, it may be desirable to initially execute a lowest cost access plan for a given query in a primary thread or task, and then utilize a secondary thread or task to build additional similar-cost access plans and add them to the cache. In such an environment, it may be that, since any resources such as tables/indices that may be referenced by the lowest cost access plan may still be in memory after the initial execution, it may still be optimal to use the same access plan to handle subsequent similar queries. If however, it is determined after some time that the access plan has a relatively high rate of usage, the optimizer may begin to randomly execute the additional similar-cost access plans for some period to generate actual cost information for such access plans, whereby a later determination may be made as to which access plan is optimal. It should also be appreciated that, in such an instance, it may be desirable to discard the actual cost information generated for the first few executions of a given access plan to enable any necessary resources to be brought into memory so that the retrieval or generation of such resources does not negatively impact access plan performance.

In addition, in some embodiments it may be desirable to store details regarding any inferior access plans with any optimal access plans so that if the optimal access plan is ever rebuilt (e.g., for functional reasons such as after applying a fixpack), the optimizer may avoid trying any such inferior access plans.

Additional modifications may be made to the illustrated embodiments without departing from the spirit and scope of the invention. Therefore, the invention lies in the claims hereinafter appended.

What is claimed is:

1. A method for selecting an access plan, the method comprising the steps of:
selecting a plurality of alternative access plans for a particular query based upon estimated costs associated with each alternative access plan;
executing the plurality of alternative access plans to generate actual costs for the plurality of alternative access plans; and
identifying an optimal access plan from among the plurality of alternative access plans based upon the generated actual costs.

2. The method of claim 1, wherein selecting the plurality of alternative access plans includes the steps of:
identifying a lowest cost access plan; and
identifying one or more additional access plans having an estimated cost similar to that of the lowest cost access plan.

3. The method of claim 2, wherein a cost estimate is similar if the estimated cost is within a predetermined threshold of the lowest cost access plan.

4. The method of claim 3, wherein the predetermined threshold is approximately 1%.

5. The method of claim 1, further comprising the steps of:
generating the plurality of alternative access plans; and
storing the generated plurality of alternative access plans in a cache.

6. The method of claim 5, wherein the step of executing includes, for each of a plurality of similar queries, selecting one of the plurality of alternative access plans to execute such query.

7. The method of claim 6, wherein selecting the one of the plurality of alternative access plans includes randomly selecting the one of the plurality of alternative access plans.

8. The method of claim 1, further comprising the step of:
after identifying the optimal access plan, executing subsequent similar queries with the identified optimal access plan.

9. The method of claim 1, further comprising the steps of:
storing information identifying each of the plurality of alternative access plans.

10. The method of claim 1, further comprising the steps of:
monitoring a state of a database on which the query is executed;
determining when the state has changed; and
in response to determining that the state has changed, repeating the steps of selecting and executing.

11. The method of claim 1, further comprising the step of:
determining for at least one of the plurality of alternative access plans whether the estimated and actual costs thereof are substantially similar.

12. The method of claim 11, further comprising the step of:
if the actual and estimated costs for the at least one of the plurality of alternative access plans differ, adding at least one additional alternative access plan to the plurality of alternative access plans.

13. A method for selecting from among a plurality of similar-cost access plans for a query, the method comprising the steps of:
for each of a plurality of similar queries, executing one of the plurality of similar-cost access plans;
identifying an access plan having better performance than the other plurality of similar-cost access plans; and
selecting the identified access plan for executing subsequent similar queries.

14. The method of claim 13, wherein the plurality of similar-cost access plans are stored in a cache.

15. The method of claim 13, wherein the plurality of similar-cost access plans are randomly selected for each of the plurality of similar queries.

16. The method of claim 13, further comprising the step of:
monitoring respective execution performance for each of the plurality of similar-cost access plans.

17. An apparatus comprising:
at least one processor;
a memory coupled with the at least one processor; and
program code resident in the memory and configured to be executed by the at least one processor to:
select a plurality of alternative access plans for a particular query based upon estimated costs associated with each alternative access plan;
execute the plurality of alternative access plans to generate actual costs for the plurality of alternative access plans; and
identify an optimal access plan from among the plurality of alternative access plans based upon the generated actual costs.

18. The apparatus of claim 17, wherein the program code is configured to select the plurality of alternative access plans by identifying a lowest cost access plan, and identifying one or more additional access plans having an estimated cost similar to that of the lowest cost access plan.

19. The apparatus of claim 18, wherein a cost estimate is similar if the estimated cost is within a predetermined threshold of the lowest cost access plan.

20. The apparatus of claim 19, wherein the predetermined threshold is approximately 1%.

21. The apparatus of claim 17, wherein the program code is further configured to:
generate the plurality of alternative access plans; and
store the generated plurality of alternative access plans in a cache.

22. The apparatus of claim 21, wherein the program code is configured to execute the plurality of alternative access plans by, for each of a plurality of similar queries, selecting one of the plurality of alternative access plans to execute such query.

23. The apparatus of claim 22, wherein the program code is configured to randomly select the one of the plurality of alternative access plans.

24. The apparatus of claim 17, wherein the program code is further configured to:
after identifying the optimal access plan, execute subsequent similar queries with the identified optimal access plan.

25. The apparatus of claim 17, wherein the program code is further configured to:
store information identifying each of the plurality of alternative access plans.

26. The apparatus of claim 17, wherein the program code is further configured to:
monitor a state of a database on which the query is executed;
determine when the state has changed; and
in response to determining that the state has changed, repeat the selection and execution of the plurality of alternative access plans.

27. The apparatus of claim 17, wherein the program code is further configured to:
determine for at least one of the plurality of alternative access plans whether the estimated and actual costs thereof are substantially similar.

28. The apparatus of claim 27, wherein the program code is further configured to:
if the actual and estimated costs for the at least one of the plurality of alternative access plans differ, add at least one additional alternative access plan to the plurality of alternative access plans.

29. A program product, comprising:
program code configured upon execution to:
select a plurality of alternative access plans for a particular query based upon estimated costs associated with each alternative access plan;
execute the plurality of alternative access plans to generate actual costs for the plurality of alternative access plans; and
identify an optimal access plan from among the plurality of alternative access plans based upon the generated actual costs; and
a computer readable signal bearing medium bearing the program code.
